(19) United States
(12) Patent Application Publication
(10) Pub. No.: US 2020/0261795 A1
(43) Pub. Date: Aug. 20, 2020

(54) FITNESS AND NUTRITION CARD GAME AND METHOD OF PLAY

(71) Applicant: NAINA SINGHANIA, MUMBAI (IN)

(72) Inventor: NAINA SINGHANIA, MUMBAI (IN)

(21) Appl. No.: 16/789,433

(22) Filed: Feb. 13, 2020

(30) Foreign Application Priority Data
Feb. 14, 2019 (IN) 201921005769

(51) Int. Cl. A63F 13/25; A63F 1/06

(52) U.S. Cl. CPC A63F 13/25; A63F 1/06

(57) ABSTRACT

A fitness and nutrition card game is provided herein. The card game includes a card deck with plurality of cards each having front and back side whereby the front side of the card is printed with an information of a code which refers to a food menu and corresponding random value denoted to the food menu. The food menu corresponding to the code may be elaborated and printed on the back side of the card which the player needs to follow to receive specific nutritional value from the food menu and a suggestion window printed on the back side of the card which includes plurality of codes referring to other food menus which the player needs to combine with said elaborated food menu of the card. The food menu and the other food menus when combined together helps the player to achieve his or her daily nutritional requirements.

### BACKGROUND

### Technical Field

The embodiments herein generally relate to a fitness and nutrition card game and more particularly to, a card game with an object of meeting daily nutritional requirements of an individual on the basis of their choice of meals. Further, the card game described herein has another object of defining a fitness regime of an individual based on their choice of cards. This game may be played by persons of varying ages and which have the combined purposes of providing entertainment and of introducing and reinforcing fitness goals of the individual.

### Description of the Related Art

Our weight and health are a direct result of our food choices. Too often, people give up easily on healthy eating because they tend to eat the same boring items over and again in an effort to lose weight. Monotonous eating will always lead to overeating or poor eating and monotonous eating is also the reason why the diet and the fast food industries is continuing to flourish. We need to step away from the trappings of the fast food of today and the false promises of the latest weight loss miracle. Today we are limited to the amount of time we can spend preparing dinners. We run out of ideas about what to make and then fall back into fast food or monotonous fare that leads to weight gain and ill health.

Also keeping track of your calories, carbs and fat grams can be complicated, but it doesn't have to be if you have a good mobile application to keep track of your calorie intake. More often if the same is gamified, the whole nutrition and calorie tracking becomes all the more fun and interesting and may serve the purpose of addressing nutritional needs of an individual.

A dieting game board apparatus is disclosed in U.S. Pat. No. 4,040,628 to Pope which emphasizes positive and negative steps for dieting. The Pope game board apparatus includes chance generating means, a plurality of playing pieces representing a dieter, weight recording means for each dieter which functions as a scoring device, a playing board having a plurality of playing spaces in substantially contiguous relationship defining a playing path, a first plurality of spaces indicating a weight gain, and a second plurality of spaces indicating a weight loss. A second embodiment of the dieting game board apparatus of the Pope invention further includes a supply of game money, a plurality of weight cards having player directives, at least one space where weight can be lost for payment of money, at least one space where weight can be gained for payment of money, and at least one space indicating that a player is to follow the directives of a weight card. Players move their playing pieces along the playing path for the number spaces indicated by the chance generating means and mark the weight recording means in turn. The winner is the first player to reduce his/her weight to zero, or in the second embodiment, the first player to lose twenty-five pounds.

In U.S. Pat. No. 4,159,117 to Kuna a boardgame designed around the theme of gaining and losing weight and counting calories is disclosed. The Kuna boardgame includes a game board having a plurality of stations defining a travel path, hollow playing pieces, a plurality of weight elements receivable within the hollow playing pieces as representations of calories, chance means which determine the number of stations traversed on a turn and the number of weight elements added to a playing piece, scale means for comparing the weight of opposing playing pieces, and second chance means to provide random gains or losses of calories. The object of the game is to finish with the least number of accumulated calories.

U.S. Pat. No. 4,174,840 to Curtiss discloses a weight control game apparatus which emphasizes the relationship between food consumption and exercise in weight control. The Curtiss game apparatus includes a gameboard for each player which has a calories gain path and a calories loss path. Chance card means determine which path a player moves along for a number of spaces based on a roll of dice. The player having lost the greatest amount of calories or gained the least amount of calories is the winner.

Accordingly, in the foregoing, there is no card game or playing methods presently available in the prior art which serves the purpose of meeting nutritional needs of an individual while playing the card game. Additionally, the card game providing or suggesting a fitness regime followed by a recommended dietary plan which includes a wholesome meal recipe depending on the player's health index is also nowhere to be found in the prior art references.

### SUMMARY

A fitness and nutrition card game is provided herein in the present embodiment. A card game played by at least one player includes a card deck with plurality of cards each having front and back side, wherein said front side of the card is printed with an information section comprising a code referring to a food menu and a random value denoted to said food menu, wherein the food menu corresponding to the code is elaborated and printed on the back side of the card which the player needs to follow to receive specific nutritional value from the food menu; and a suggestion window printed on the back side of the card which includes plurality of codes referring to other food menus which the player needs to combine with said elaborated food menu of the card, wherein said food menu and the other food menus when combined together helps the player to receive his or her daily nutritional requirements.

In an embodiment, the player may randomly choose any card from the card deck. The food menu includes menus for breakfast lunch, snack and dinner. In an embodiment, the front side of the card further comprises any ranks from a standard card deck having four suits like clubs, spades, diamonds and hearts with each suit having an ace, a king, queen, jack each depicted with a symbol of respective suits and ranks two through ten printed on the front side of the card.

In one embodiment, the suggestion window may include instructions or guidelines which the player needs to follow while combining the food menus. The card may be printed with an additional food menu which is to be optionally combined with said food menu and other suggested food menus by the player to receive his or her daily nutritional requirements.

In an embodiment, the card deck with plurality of cards each having front and back side, wherein said front side of the card is printed with an information section comprising a code referring to a fitness regime, wherein the fitness regime corresponding to the code is elaborated and printed on the back side of the card which the player needs to follow to achieve partial fitness goals set by the player; and a suggestion window printed on the back side of the card which includes plurality of codes referring to other fitness regimes which the player needs to combine with said elaborated fitness regime of the card, wherein said fitness regime and the other fitness regime when combined together helps the player to achieve his or her daily fitness goals.

A method of playing card game is provided herein, said method includes steps of pulling at least one card having front and back side from a card deck by at least one player playing at a time; viewing front side of the card to obtain a code related to a food menu; referring to the food menu which is printed on back side of the card corresponding to the code; following the food menu as printed on back side of the card by the player to fulfil his or her partial nutritional requirements; referring to a suggestion window printed on the back side of the card which includes plurality of codes for other food menus; picking any one code from the plurality of codes to obtain a specific food menu from the other food menus; and combining said food menu and the specific food menu together to help the player achieve his or her daily nutritional requirements.

In an embodiment, the player may be able to play a standard card game concurrently with the nutrition or fitness game. In another embodiment, the player plays at any one instance the nutrition or fitness game. In yet another embodiment, the player may play the nutrition and fitness games concurrently.

Other and further aspects and features of the disclosure will be evident from reading the following detailed description of the embodiments, which are intended to illustrate, not limit, the present disclosure.

10

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments:

The embodiments herein will be better understood from the following detailed description with reference to the drawings, in which:

FIG. 1 represents a nutrition card game wherein (a) is a front-schematic view of the card game depicting a breakfast menu code and a random value denoted to the menu and (b) is a back-schematic view of the card game elaborating the breakfast menu according to an embodiment mentioned herein;

FIG. 2 represents the nutrition card game wherein (a) is a front-schematic view of the card game depicting a lunch menu code and a random value of the menu and (b) is a back-schematic view of the card game elaborating the lunch menu according to an embodiment mentioned herein;

FIG. 3 represents the nutrition card game wherein (a) is a front-schematic view of the card game depicting an evening snack code and (b) is a back-schematic view of the card game elaborating the evening snack menu according to an embodiment mentioned herein;

FIG. 4 represents the nutrition card game apparatus wherein (a) is a front schematic view of the card game depicting a dinner code and (b) is a back-schematic view of the card game elaborating the dinner menu according to an embodiment mentioned herein;

FIG. 5 illustrates the nutrition card game wherein a front-schematic view of a joker card with code and random value is represented according to an embodiment mentioned herein;

FIG. 6 illustrates the nutrition card game wherein a back-schematic view of the joker card elaborating the menu is represented according to an embodiment mentioned herein;

FIG. 7 represents a fitness card game wherein (a) is a front-schematic view of the card game depicting a code for cardio fitness regime and (b) is a back-schematic view of the card game elaborating the cardio fitness regime according to an embodiment mentioned herein;

FIG. 8 is a back-schematic view of the card game illustrating a flexibility exercise for that card and a suggestion window suggesting plurality of fitness regimes through plurality of codes according to an embodiment mentioned herein;

FIG. 9 illustrates the fitness card game wherein a back-schematic view of the joker card in the card game is represented according to an embodiment mentioned herein; and

FIG. 10 is method playing a card game according to an embodiment mentioned herein.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DETAILED DESCRIPTION OF PREFERRED EMBODIMENTS

Although specific terms are used in the following description for the sake of clarity, these terms are intended to refer only to the particular structure of the invention selected for illustration in the drawings, and are not intended to define or limit the scope of the invention.

References in the specification to “one embodiment” or “an embodiment” member that a particular feature, structure, characteristics, or function described in connection with the embodiment is included in at least one embodiment of the invention. The appearances of the phrase “in one embodiment” in various places in the specification are not necessarily all referring to the same embodiment.

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Accordingly, there is no card game or playing methods presently available in the prior art which serves the purpose of meeting nutritional needs of an individual while playing a card game. Additionally, the card game providing or suggesting a fitness regime followed by a recommended dietary plan which includes a wholesome meal recipe depending on the player's health index is also nowhere to be found in the prior art references.

The present embodiments herein provide a fitness and nutrition game apparatus. The object of the present card game apparatus is not only just limited to provide entertainment to the individuals playing but also helps in meeting daily nutritional requirements of an individual on the basis of their choice of meals. Here a standard card deck of 55 cards may be used in the gaming apparatus. The cards may be divided into 4 categories wherein card of spades is denoting breakfast and coded as B1, B2, etc., card of hearts is denoting lunch and coded as L1, L2, etc., card of spades is denoting evening snacks and coded as S1, S2, etc. and card of diamonds is denoting dinner and coded as D1, D2, etc.

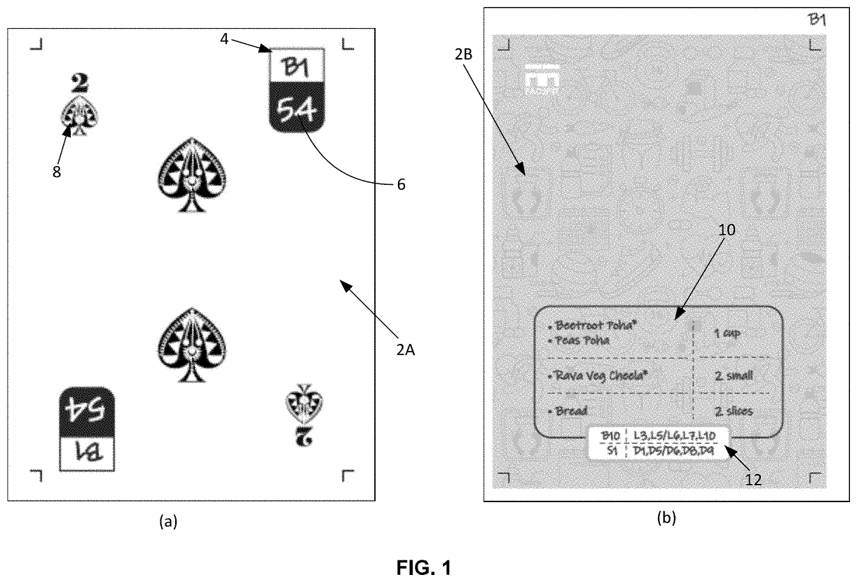

Further, the cards may also be divided into 4 categories wherein card denoting weight or strength training is coded as W1, W2, etc., card denoting cardio exercises may be coded as C1, C2, etc., card denoting flexibility activities or exercises is coded as F1,F2, etc. and card denoting sports activities is coded as S1 S2, etc. Referring now to the figures, more particularly from FIG. 1 to FIG. 10, where similar reference characters denote corresponding features consistently throughout the figures, preferred embodiments are shown.

FIG. 1 represents a nutrition card game wherein (a) is a front-schematic view 2A of the card game depicting a breakfast menu code 4 and random value 6 of the menu and (b) is a back-schematic view 2B of the card game elaborating the breakfast menu 10 according to an embodiment mentioned herein. In an embodiment, each card has been divided on the basis of calories and macronutrients which may be denoted a random value.

In the front schematic view 2A of the card of spades, a breakfast card B1 has been coded with a pre-determined number say for example card B1 coded with 54, so that each card can be combined with other meals to add up to a certain number so that they form a balanced meal. This certain number may be calculated based on the calorie requirements of the individual, calorific value of a food recipe, fitness regime that an individual may adopt combined with the food recipe or any random number may be denoted to the food menu.

In the back-schematic view 2B, a breakfast menu 10 may be elaborated to enable to choose what food recipe an individual may choose with respect to his card selection say B1 referring to FIG. 1. Accordingly, he may also be guided as to what menu he should select for his lunch, evening snack dinner, etc. This guidance may be provided through a suggestion window 12.

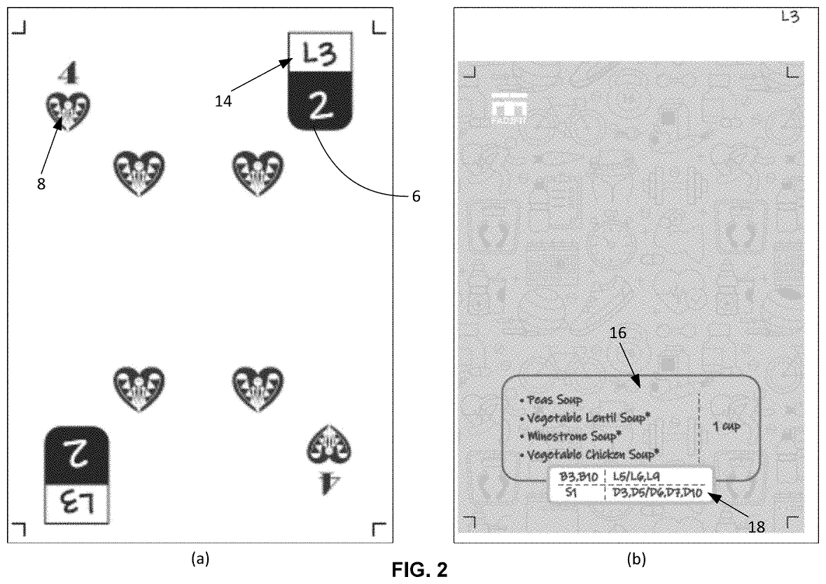

FIG. 2 represents the nutrition card game wherein (a) is a front-schematic view of the card game depicting a lunch menu code and a random value denoted to the menu and (b) is a back-schematic view of the card game elaborating the lunch menu according to an embodiment mentioned herein. Here the card of hearts in the front—schematic view 2A is related to the lunch menu and may be coded with L1, L2, L3, etc. corresponding with a predetermined number . For e.g. Card L3 coded with 2 in this case which is in turn the corresponding to the random value denoted to the lunch menu L3.

In the back-schematic view of the game card, a lunch menu 16 may be described to enable to choose what food recipe an individual may choose with respect to his card selection say L3 referring to FIG. 2. Accordingly, he may also be guided as to what menu he or she should select for his lunch, evening snack, dinner, etc. This guidance may be provided through a suggestion window 18.

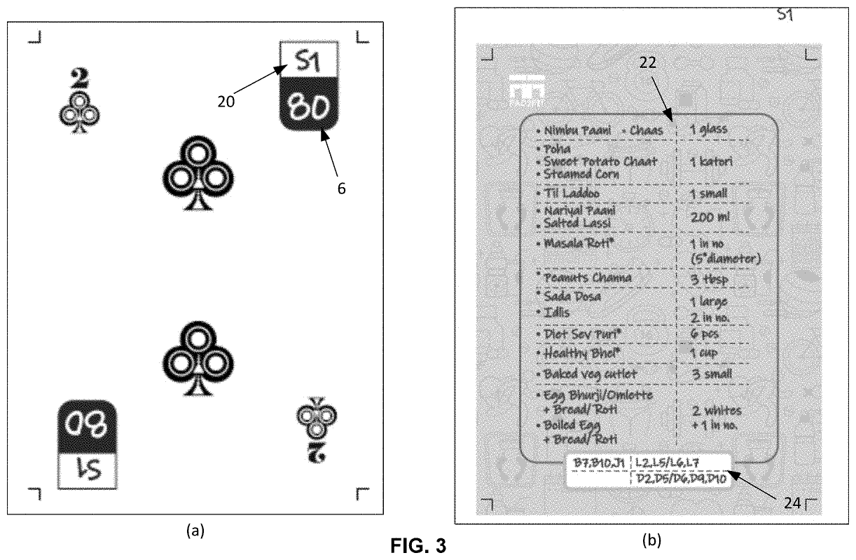

FIG. 3 represents the nutrition card game wherein (a) is a front-schematic view of the card game depicting an evening snack code and (b) is a back-schematic view of the card game elaborating the evening snack menu according to an embodiment mentioned herein. Here the card of clubs in the front—ematic view is related to the evening snacks and may be coded with S1, S2, S3, etc. corresponding with a predetermined number. For e.g. card S1 coded with 80 in this case which is in turn the corresponding random value denoted to the snacks menu S1.

In the back-schematic view of the game card, a snacks menu 22 may be described to enable to choose what food recipe an individual may choose with respect to his card selection say Si referring to FIG. 3. Accordingly, he may also be guided as to what menu he should select for his lunch, evening snack dinner, etc. This guidance may be provided through a suggestion window 24.

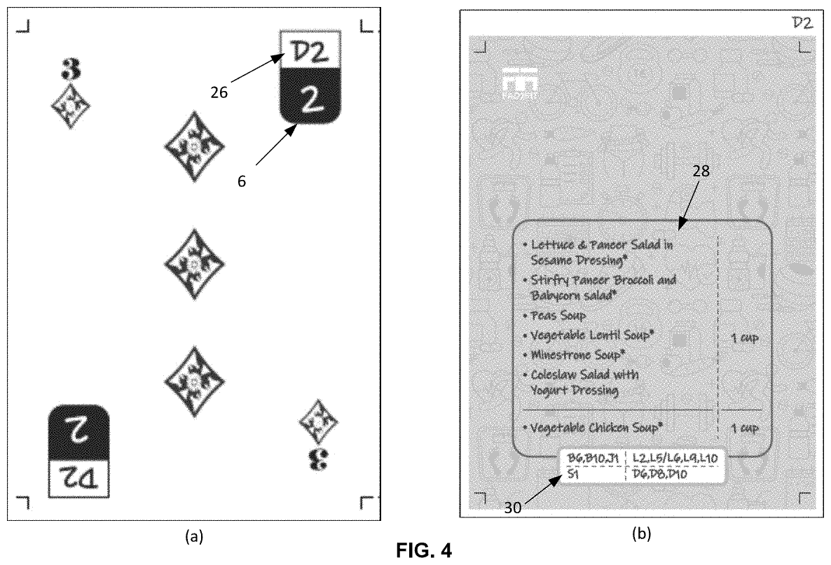

FIG. 4 represents the nutrition card game apparatus wherein (a) is a front schematic view of the card game depicting a dinner code and (b) is a back-schematic view of the card game elaborating the dinner menu according to an embodiment mentioned herein. Here the card of diamonds in the front—schematic view is related to dinner and may be coded with D1, D2, D3, etc. corresponding with a predetermined number. For e.g. card D2 coded with 2 in this case which is in turn the corresponding random value denoted to the dinner menu D2.

In the back-schematic view of the game card, a dinner menu 28 may be described to enable to choose what food recipe an individual may choose with respect to his card selection say D2 referring to FIG. 4. Accordingly, he may also be guided as to what menu he should be selecting for his or her lunch, evening snack, dinner, etc. This guidance may be provided through a suggestion window 30.

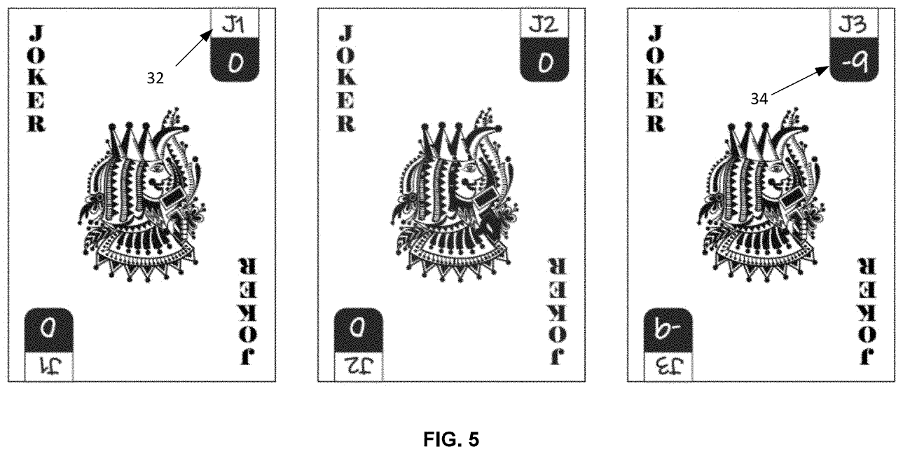

FIG. 5 illustrates the nutrition card game wherein a front-schematic view of a joker card with a code and random value is represented according to an embodiment mentioned herein. In an embodiment, there are three joker cards and may be represented as J1, J2 and J3. The joker cards may be coded with a predetermined random number similar to other cards in the deck. In an example embodiment, the joker card J1 and J2 may be coded with number 0 and joker card J3 may be coded with −9. In one example embodiment, the coded number may represent the respective calorie value obtained from the menu or the joker card.

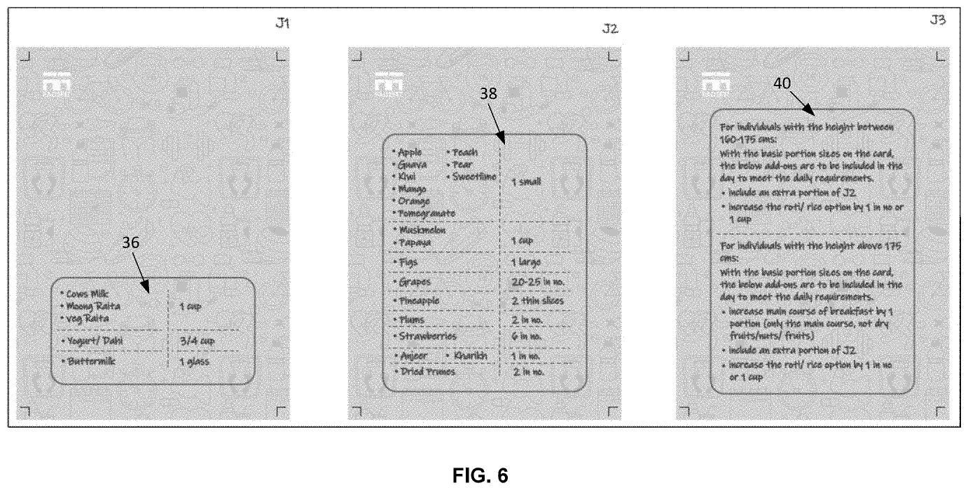

FIG. 6 illustrates the nutrition card game wherein a back-schematic view of the joker card elaborating the menu is represented according to an embodiment mentioned herein. In an embodiment, the joker J1 and J2 may be included as an additional menu which may be combined with any of the breakfast, lunch or dinner menus. The joker card J3 may include instructions for the players suggesting certain dietary inclusions or exclusions depending on their body height, weight, BMI, etc.

The gaming apparatus of the present embodiment which is related to a card game may be have multiple games one of which may be related to fitness and nutrition needs of the individual.

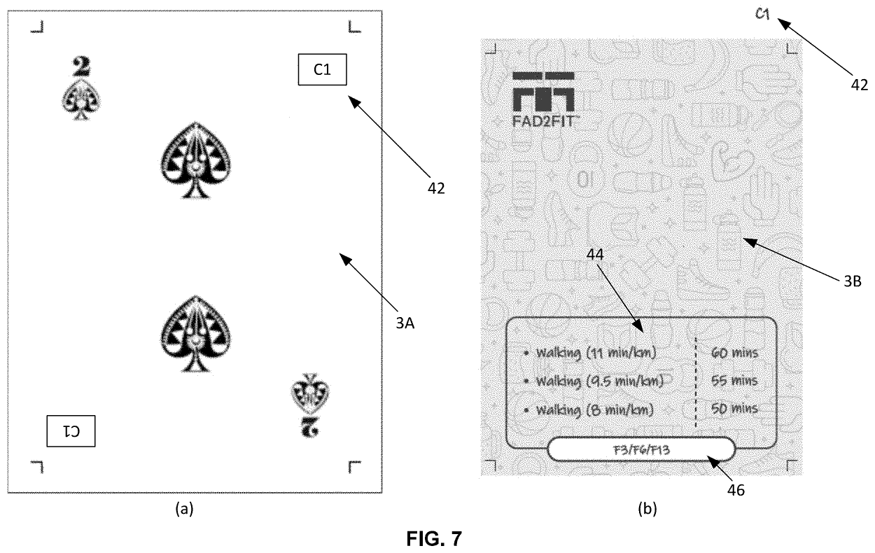

FIG. 7 represents a fitness card game wherein (a) is a front-schematic view 3A of the card game depicting a code 42 for cardio fitness regime and (b) is a back-schematic view 3B of the card game elaborating the cardio fitness regime according to an embodiment mentioned herein. In the front schematic view 3A, card of spades is a card denoting cardio exercises and has been coded as C1. The cardio fitness regime may be elaborated on the backside of the card for the players to follow the regime.

Accordingly, the player may also be guided to other fitness regime that he should be combining in order to achieve his fitness goals. This guidance or suggestion may be provided through a suggestion window 46. In an example embodiment, the cardio exercises C1 may be combined with the flexibility activities such as F3/F6/F13.

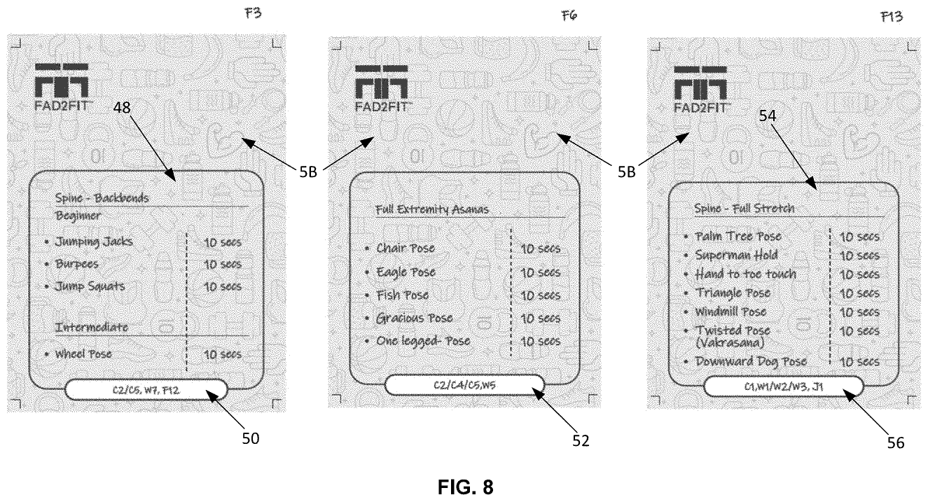

FIG. 8 is a back-schematic view of the card game illustrating a flexibility exercise for that card and a suggestion window suggesting plurality of fitness regimes through plurality of codes according to an embodiment mentioned herein. In an example embodiment, the flexibility activity cards such as F3, F6 and F13 is depicted herein. In an embodiment, the flexibility activities may be elaborated in a menu 48 which the player needs to follow in order to achieve his or her partial fitness goals. Further, through suggestion windows 50, 52 or 56 of the respective flexibility activity cards the player is suggested to choose other fitness cards which he can combine with the selected card for achieving his or her fitness goals for the day.

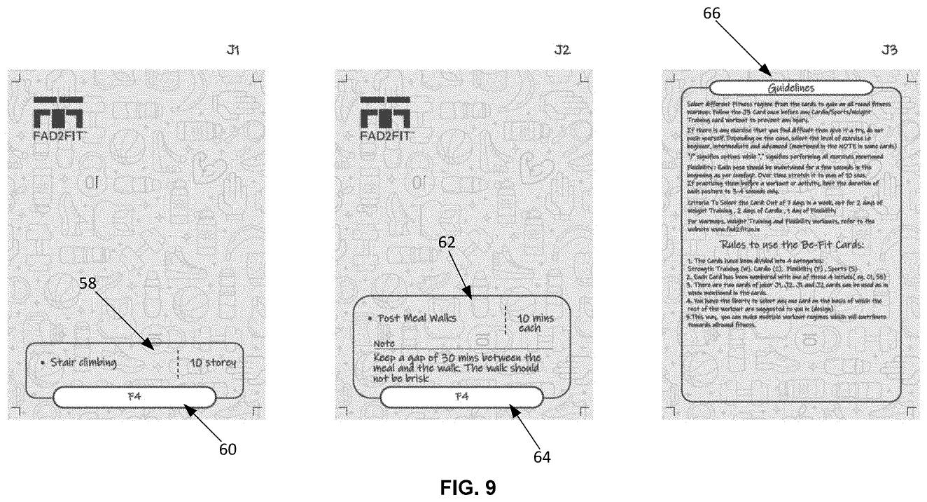

FIG. 9 illustrates the fitness card game wherein a back-schematic view of the joker card in the card game is represented according to an embodiment mentioned herein. In an embodiment, the joker J1 and J2 may be included as an additional or optional cards which the player may combine with any of the fitness regimes cards from the strength training, cardio exercises, sports activities and flexibility activities or exercises categories. The joker card J3 may include instructions for the players on how to select different fitness regime according to their body height, weight, BMI, etc.

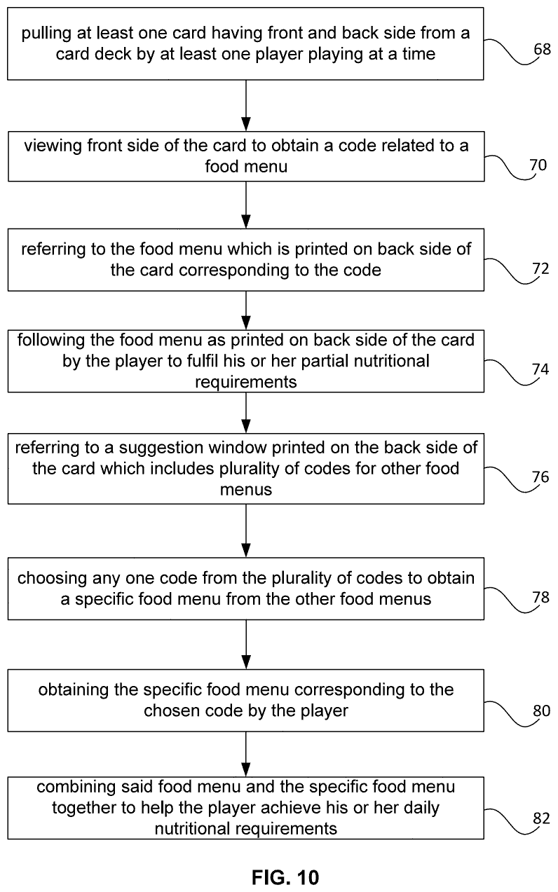

FIG. 10 is method playing a card game according to an embodiment mentioned herein. In step 68, at least one card from a card deck is pulled by at least one player playing at a time. In step 70, front side of the card may be viewed to obtain a code related to a food menu. In step 72, the food menu which is printed on back side of the card is referred which may be corresponding to the code. In step 74, the food menu as printed on back side of the card may be followed by the player to fulfil his or her partial nutritional requirements. In step 76, a suggestion window printed on the back side of the card may be referred by the player which includes plurality of codes for other food menus. In step 78, any one code from the plurality of codes may be chosen by the player in order to obtain a specific food menu from the other food menus.

In step 80, the specific food menu corresponding to the chosen code may be obtained by the player. In step 82, the food menu and the specific food menu together may be combined to help the player achieve his or her daily nutritional requirements.

In an example embodiment, for Game 1: to be a winner the individual may need to make a set with a score of 81 in each of the 4 colours or meal. Here each set should be of minimum 2 and maximum of 5 cards. All the 4 sets should be made from minimum 8 cards and maximum 13 cards.

To begin the game, each player should have 8 cards each. In every turn the individual has to pick a card. On the respective turn one can pick a card from the from the card deck or from the last discarded card by the opponent. At any point one is not allowed to hold more than 13 cards. The individual can burn the cards on the respective turn in the center from where the opponent can pick the latest discarded card on his turn to make a set for his meals. When the cards in the deck gets exhausted, the cards in the center may be shuffled and reused as the deck.

In an example embodiment, for Game 2: to be a winner will be one who makes a set 4 colours or meal. All the 4 sets should be made from minimum 8 cards and maximum 13 cards. Here each set should be of minimum 2 and a maximum of 5 cards.

To begin the game, 14 cards are distributed among 3 players and 13 cards to the 4^{th} player. The player with 13 cards is the first one to pull a card from the next player. The process continues. While doing so, the player has to keep making a set and place it aside. This however, has to be done on the turn of the player. The one who makes all four sets first wins.

In an advantageous embodiment of the present disclosure the gaming apparatus of the present embodiment may also be used as a health cards. Certain rules may be followed to use the game cards as the health cards one of which is by choosing one dish and getting the day's plan. From the deck of cards which is divided in 4 categories breakfast-spades, lunch-hearts, evening snack-clubs and dinner-diamond. Each of the cards has been numbered with one of these initials for e.g. B1, D3, L4, etc. Along with 4 categories, each card is also marked with certain predetermined numbers which may be printed below these initials say for e.g. card related to breakfast where the initial is B1 and corresponding number is 54.

The any three jokers J1, J2 and J3 where J1 and J2 may be used as and when mentioned in the above respective cards. The individual has a liberty to select any one meal/part of meal of the day on the basis of which the rest of the meals are suggested.

The suggestion may be in the suggestion window (for e.g. 12, 18, 24, 30, etc. represented in FIG. 1-4).

From the selected card one can opt any one dish with the servings mentioned in that card. The individual can make multiple menus in this way which will contribute towards sustainable and healthy lifestyle. For individuals with height above 160 cm the joker card J3 may be referred.

In another advantageous embodiment of the present disclosure the gaming apparatus of the present embodiment may also be used as a health cards. Certain rules may be followed to use the game cards as the health cards one of which is by planning the entire day by the individuals themselves by making a predetermined score say for e.g. 81.

Here in order to make the daily menu, the individual needs to make a total of 81 in each of the 4 colours or meals. While making the set, one can use minimum of 2 and maximum of 5 cards in each of the 4 meal or colour. The joker cards J1 and J2 may be used with any of the other cards and the value of the same is ‘0’. The joker card J3 is a card with value −9 and can be combined with S2 or S3 only. The individual is allowed to have minimum of 8 and maximum of 13 cards to make the entire days menu. One can make various combination of a predetermined number say 81 in this case for each meal to add more variety to the daily food menu.

The disclosure of the present embodiment in addition to the combined purposes of providing entertainment also provides freedom from planning everyday meals, freedom from same monotonous meal options, keeping the calorie intake more or less standard so that the user does not have to think or worry about excess calorie intake daily, giving the individual a fitness option along with the meals suggested.

Further advantage also combines healthy option with unhealthy or cheat meals to meet daily nutritional requirements of the individual. Also suggesting a fitness option on the basis of unhealthy or cheat meals or days. In addition to the use of the game cards as health cards as described in the present embodiment, the game cards may be also used as a fitness card whereby a fitness regime or goals may be suggested to the individual depending on this body type and this fitness regime may also be combined with the recommended or corresponding dietary plan.

In an embodiment, the logic used in this card game is not just limited to fulfilling fitness or nutritional goals of the individual but may also mimic other aspects such as fashion, food recipe combination, etc. Here for fashion or clothing-makeup combination, hair styling, accessories matching with the clothing etc. may be prescribed or suggested as per the card combination by the player. For food recipes various food preparation or menu can be combined to set up best food menu combination that go along. However, the fundamental idea of referring to code and elaborating the same at the back of the card along with suggestion window to achieve the desired results remains the same.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A card game played by at least one player comprising:
a card deck with plurality of cards each having front and back side, wherein said front side of the card is printed with an information section comprising a code referring to a food menu and a random value denoted to said food menu, wherein the food menu corresponding to the code is elaborated and printed on the back side of the card which the player needs to follow to receive specific nutritional value from the food menu; and
a suggestion window printed on the back side of the card which includes plurality of codes referring to other food menus which the player needs to combine with said elaborated food menu of the card, wherein said food menu and the other food menus when combined together helps the player to receive his or her daily nutritional requirements.

2. The card game of claim 1, wherein the player randomly chooses any card from the card deck.

3. The card game of claim 1, wherein the food menu includes menus for breakfast lunch, snack and dinner.

4. The card game of claim 1, wherein the front side of the card further comprises any ranks from a standard card deck having four suits like clubs, spades, diamonds and hearts with each suit having an ace, a king, queen, jack each depicted with a symbol of respective suits and ranks two through ten printed on the front side of the card.

5. The card game of claim 1, wherein the suggestion window comprises instructions or guidelines which the player needs to follow while combining the food menus.

6. The card game of claim 1, wherein the card is printed with an additional food menu which is to be optionally combined with said food menu and other suggested food menus by the player to receive his or her daily nutritional requirements.

7. A card game played by at least one player comprising:
a card deck with plurality of cards each having front and back side, wherein said front side of the card is printed with an information section comprising a code referring to a fitness regime, wherein the fitness regime corresponding to the code is elaborated and printed on the back side of the card which the player needs to follow to achieve partial fitness goals set by the player; and
a suggestion window printed on the back side of the card which includes plurality of codes referring to other fitness regimes which the player needs to combine with said elaborated fitness regime of the card, wherein said fitness regime and the other fitness regime when combined together helps the player to achieve his or her daily fitness goals.

8. The card game of claim 7, wherein the player randomly chooses any card from the card deck.

9. The card game of claim 7, wherein the fitness regime includes cardio exercises, flexibility exercises, sports activities and weight training.

10. The card game of claim 7, wherein the front side of the card further comprises any ranks from a standard card deck having four suits like clubs, spades, diamonds and hearts with each suit having an ace, a king, queen, jack each depicted with a symbol of respective suits and ranks two through ten printed on the front side of the card.

11. A method of playing card game, said method comprising:
pulling at least one card having front and back side from a card deck by at least one player playing at a time;
viewing front side of the card to obtain a code related to a food menu;
referring to the food menu which is printed on back side of the card corresponding to the code;
following the food menu as printed on back side of the card by the player to fulfil his or her partial nutritional requirements;
referring to a suggestion window printed on the back side of the card which includes plurality of codes for other food menus;
choosing any one code from the plurality of codes to obtain a specific food menu from the other food menus;
obtaining the specific food menu corresponding to the chosen code by the player; and
combining said food menu and the specific food menu together to help the player achieve his or her daily nutritional requirements.

12. The method of playing card game of claim 11, wherein said player randomly chooses any card from the card deck.

13. The method of playing card game of claim 11, wherein the code further comprises code referring to a fitness regime.

14. The method of playing card game of claim 13, wherein the fitness regime corresponding to the code is elaborated and printed on the back side of the card which the player needs to follow to achieve partial fitness goals set by the player.

15. The method of playing card game of claim 11, the suggestion window printed on the back side of the card further includes plurality of codes referring to other fitness regimes which the player needs to combine with said elaborated fitness regime of the card, wherein said fitness regime and the other fitness regime when combined together helps the player to achieve his or her daily fitness goals.

16. The method of playing card game of claim 11, wherein the food menu includes menus for breakfast lunch, snack and dinner.

17. The method of playing card game of claim 11, wherein the fitness regime includes cardio exercises, flexibility exercises, sports activities and weight training.

18. The method of playing card game of claim 11, wherein the player is able to play a standard card game concurrently with nutrition or fitness game.

19. The method of playing card game of claim 18, wherein the player plays at any one instance the nutrition or fitness game.

20. The method of playing card game of claim 18, wherein the player plays the nutrition and fitness games concurrently.
